(19) United States
(12) Patent Application Publication
(10) Pub. No.: US 2026/0295964 A1
(43) Pub. Date: Oct. 1, 2026

(54) ROLLER PRESS ASSEMBLY INCLUDING INFEED AND OUTFEED GUARD ASSEMBLIES

(71) Applicant: Illinois Tool Works Inc., Glenview, IL (US)

(72) Inventors: Mathew Nickolas Milton, Vancouver, WA (US); Jaime Luis Flores, Dallas, TX (US)

(21) Appl. No.: 19/335,804

(22) Filed: Sep. 22, 2025

Related U.S. Application Data
(60) Provisional application No. 63/778,939, filed on Mar. 27, 2025.

(51) Int. Cl. B30B 15/14; B30B 3/04; B30B 15/04; B30B 15/10; B30B 15/30

(52) U.S. Cl. CPC B30B 15/142; B30B 3/04; B30B 15/041; B30B 15/10; B30B 15/30

(57) ABSTRACT

A press assembly including a roller press including a main roller section having an infeed side defining an inlet and an outfeed side defining an outlet, an infeed guard assembly positioned adjacent to the infeed side of the main roller section, and an outfeed guard assembly positioned adjacent to the outfeed side of the main roller section.

### PRIORITY

This application claims priority to and the benefit of U.S. Provisional Patent Application 63/778,939, filed Mar. 27, 2025, the entire contents of which are incorporated herein by reference.

### BACKGROUND

Wooden trusses are widely used throughout the construction industry. Wooden trusses are often built from conventional dimensional lumber members (such as what is commonly known as: a 2 by 4; a 2 by 6; a 2 by 8; etc.). The wooden members that are used to build a wooden truss are sometimes called truss members in general with the most common truss member types sometimes called chord members and web members. Such chord members extend longitudinally along the length of the truss and such web members extend transversely to the length of the truss such as along the width of the truss. A wooden truss is often built from numerous wooden truss members and metal connectors. The metal connectors are used to attach the truss members to build the wooden truss. Wooden trusses are often prefabricated in a factory and then shipped to a construction site where the wooden trusses are used to construct part of the structure of a building (such as a house or commercial facility). Buildings constructed with such prefabricated wooden roof trusses are often more economical and faster to construct than buildings constructed with conventional stick framed structures.

Various roller presses have been developed and commercialized to securely connect the metal connectors to the truss members.

### SUMMARY

The present disclosure provides a roller press assembly with guard assemblies, methods of operation thereof, and various components and combinations of components thereof.

In various embodiments, the present disclosure relates to a roller press assembly including a roller press, an infeed guard assembly, and an outfeed guard assembly. In various embodiments, the present disclosure also relates to methods of operating the roller press assembly with the infeed and outfeed guard assemblies.

In various embodiments, the present disclosure relates to an infeed guard assembly for a roller press. In various embodiments, the present disclosure relates to methods of operating the infeed guard assembly.

In various embodiments, the present disclosure relates to an outfeed guard assembly for a roller press. In various embodiments, the present disclosure relates to methods of operating the outfeed guard assembly.

Additional features and advantages of the present disclosure are described in, and will be apparent from, the following Detailed Description and the Figures.

### BRIEF DESCRIPTION OF THE FIGURES

FIG. 1 is an isometric view of a roller press assembly including infeed and outfeed guard assemblies in accordance with one example embodiment of the present disclosure.

FIG. 2 is a second isometric view of the roller press assembly with the infeed and outfeed guard assemblies of FIG. 1.

FIG. 3 is an enlarged fragmentary perspective view of part of the infeed side of the roller press assembly of FIG. 1.

FIG. 4 is a further enlarged fragmentary perspective view of part of the infeed side of the roller press assembly of FIG. 1.

FIG. 5 is a further enlarged fragmentary perspective view of part of the infeed side of the roller press assembly of FIG. 1.

FIG. 6 is a further enlarged fragmentary perspective view of part of the infeed side of the roller press assembly of FIG. 1.

FIG. 7 is a further enlarged fragmentary perspective view of part of the infeed side of the roller press assembly of FIG. 1.

FIG. 8 is a further enlarged fragmentary perspective view of part of the infeed side of the roller press assembly of FIG. 1.

FIG. 9 is a further enlarged fragmentary perspective view of part of the infeed side of the roller press assembly of FIG. 1.

FIG. 10 is a further enlarged fragmentary perspective view of part of the outfeed side of the roller press assembly of FIG. 1.

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

Various embodiments of the present disclosure relate to a roller press assembly including a roller press, an infeed guard assembly connected to the infeed side of the roller press, and an outfeed guard assembly connected to the outfeed side of the roller press. Various embodiments of the present disclosure also relate to methods of operating a roller press assembly with such components.

In various embodiments, the present disclosure relates to an infeed guard assembly for a roller press. Various embodiments of the present disclosure also relate to methods of operating an infeed guard assembly with the roller press.

In various embodiments, the present disclosure relates to an outfeed guard assembly for a roller press. Various embodiments of the present disclosure also relate to methods of operating an outfeed guard assembly with the roller press.

Example embodiments of the roller press assembly of the present disclosure are discussed below; however, it should be appreciated that the present disclosure is not limited to the illustrated example roller press assembly or the example components thereof.

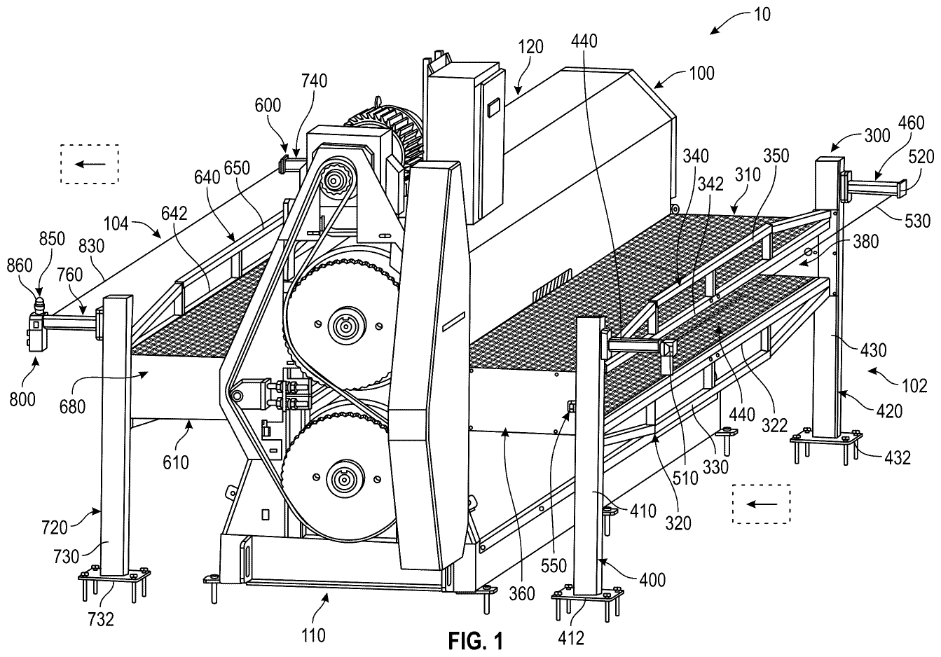

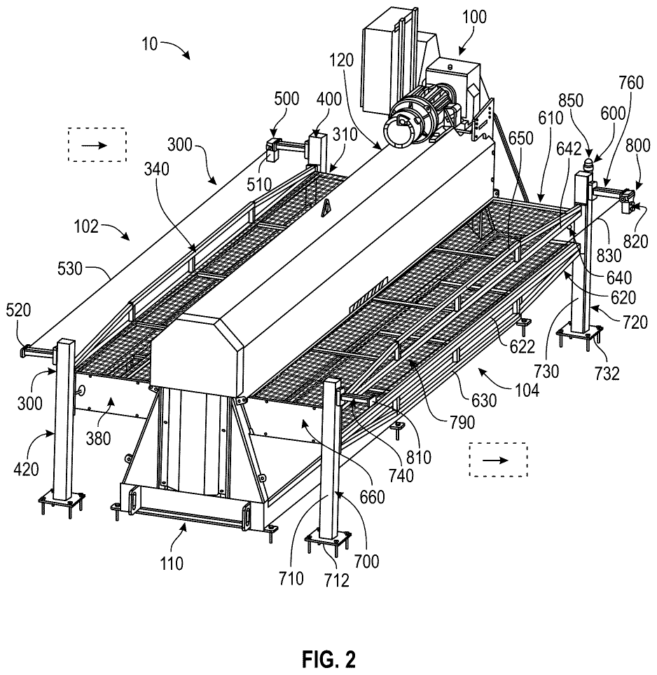

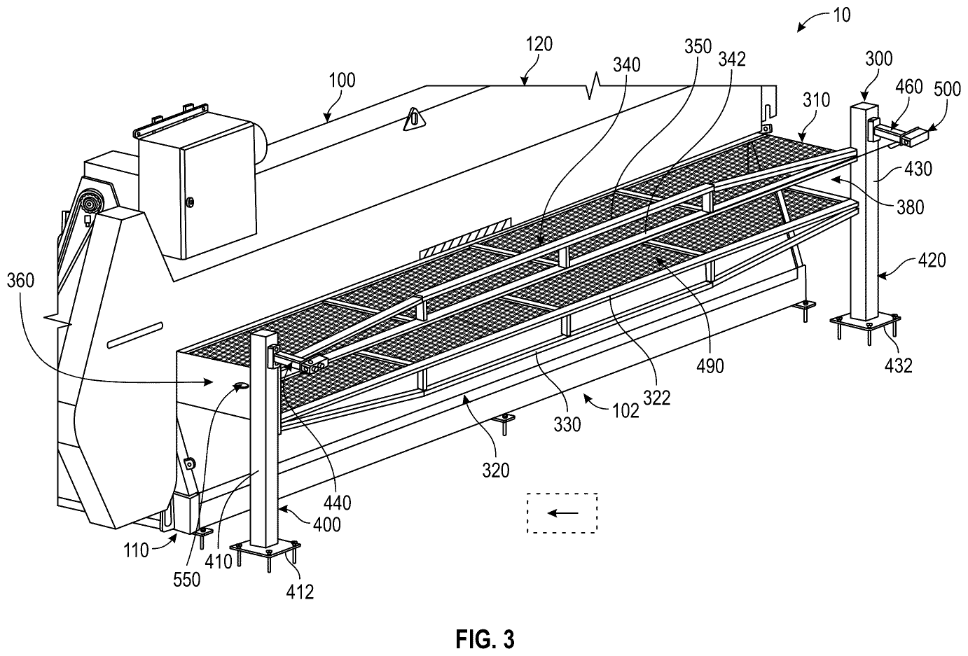

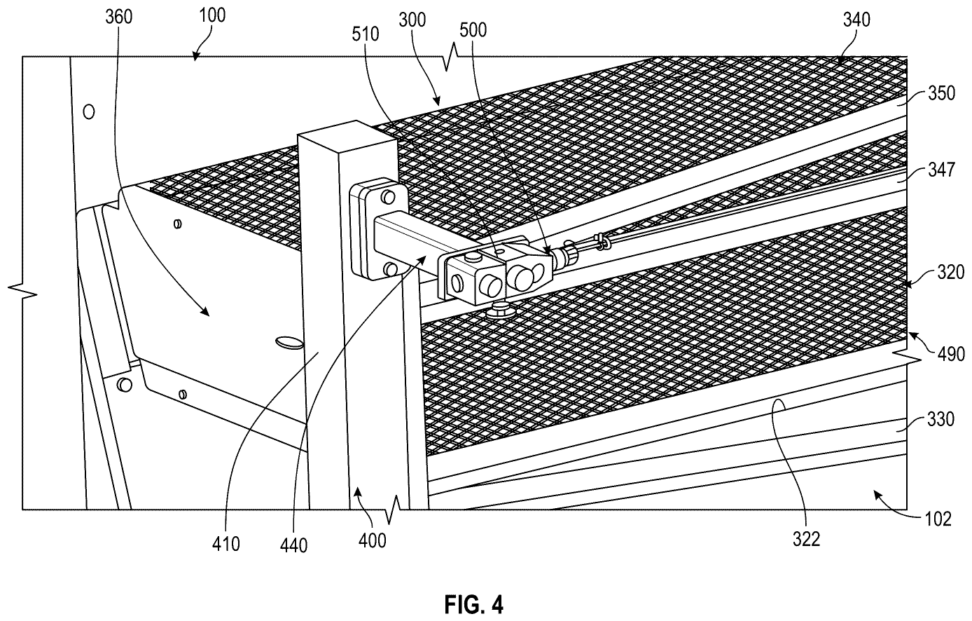

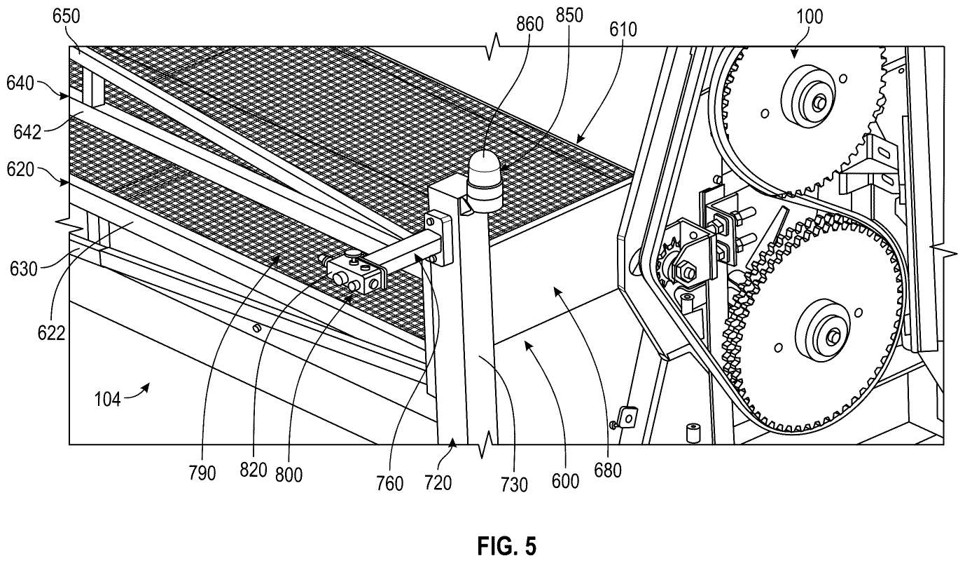

FIGS. 1 to 10 show a roller press assembly 10 (and various components thereof) of one example embodiment of the present disclosure.

This example roller press assembly 10 generally includes: (1) a roller press 100; (2) an infeed guard assembly 300; (3) an outfeed guard assembly 600; (4) a controller (not shown); (5) an operator interface (not shown); and (6) a power supply (not shown).

This example roller press 100 includes an infeed side 102 and an outfeed side 104 and is configured to receive a partially built truss (not shown) to fully secure connectors to the truss members and thus to complete the building of the truss. The partially built truss enters into the roller press 100 from the infeed side 102 of the roller press 100 and then exits from the outfeed side 104 of the roller press 100.

This example roller press 100 includes a frame 110 including a plurality of connected frame components (not individually labeled) that are configured and connected in a suitable manner to support the other components of the roller press 100. These frame components can take any suitable shape, can be formed in any suitable manner, and can be formed from any suitable materials. The roller press 100 has a transverse width that is greater than the width of any truss that is received by the roller press 100.

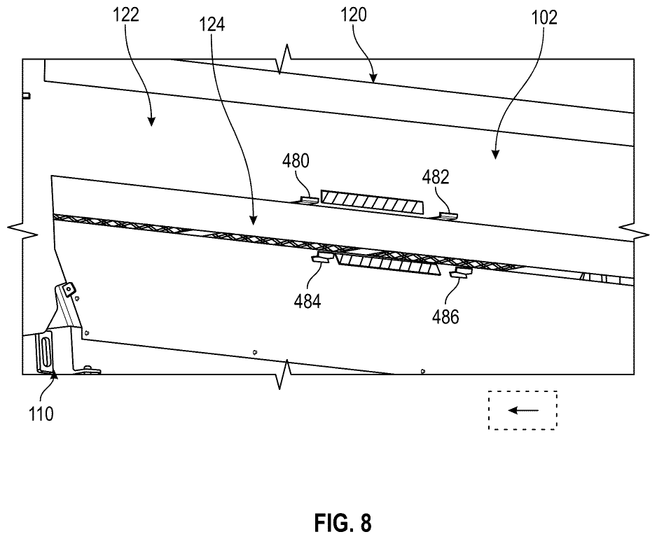

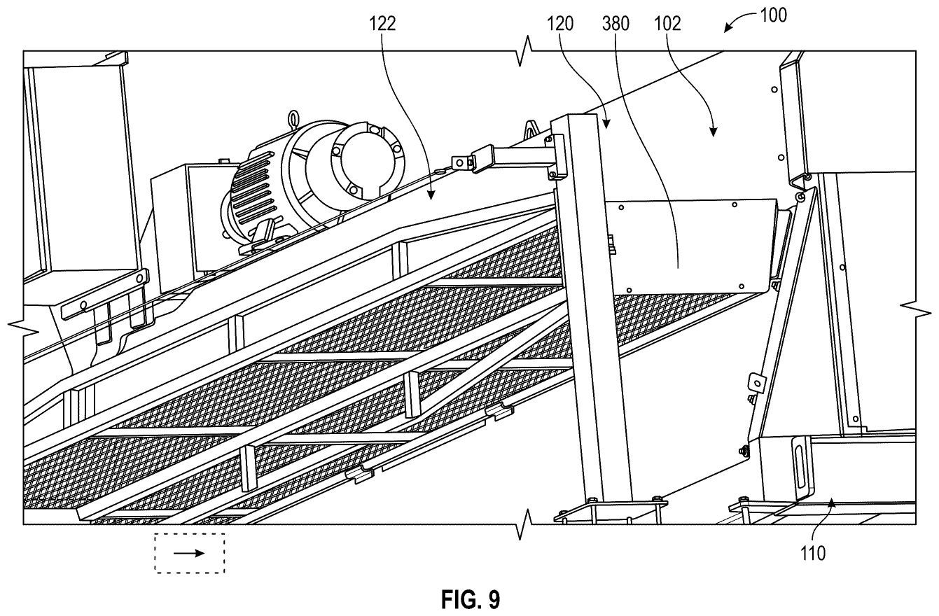

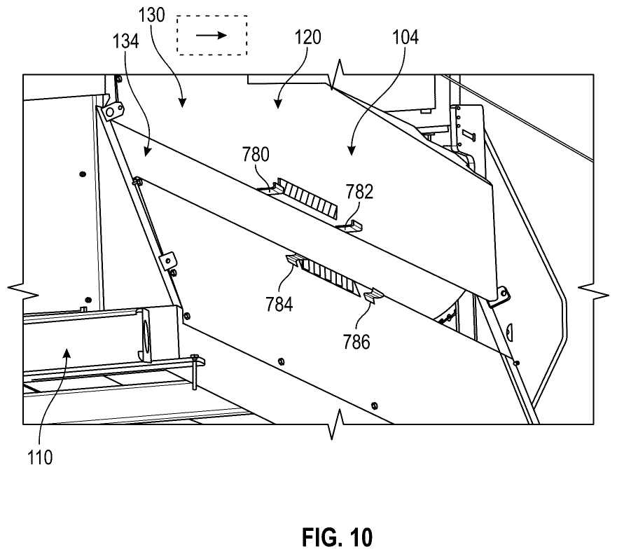

This example roller press 100 includes a main roller section (that includes two rollers (not labeled) mounted on and supported by the frame 110 and configured to secure connection plates to the truss members (such as chord members and web members) of the truss. This example roller press 100 and main roller section 120 includes various components that are not described herein for brevity but that are well known in the roller press and truss assembly industry. The main roller section 120 includes an infeed side 122 best shown in FIGS. 8 and 9 and an outfeed side 130 best shown in FIG. 10. This example roller press 100 includes an inlet 124 best shown in FIG. 8 and an outlet 134 best shown in FIG. 10.

### Infeed Guard Assembly

The infeed guard assembly 300 is sized, shaped, and otherwise configured to be positioned adjacent to and connected to the infeed side 122 of the main roller section 120 and partially in the inlet 124.

The infeed guard assembly 300 includes: (1) an infeed canopy 310; (2) a first sensor and specifically a cable pull assembly 500 for triggering an e-stop connected to and supported by the infeed canopy 310; and (3) a second sensor and specifically a second material present sensor assembly 550 connected to and supported by the infeed canopy 310.

The infeed canopy 310 includes: (1) a bottom guard 320; (2) a top guard 340; (3) a first side guard 360; (4) a second side guard 380; (5) a first support leg 400; (6) a second support leg 420; (7) a first sensor support arm 440; and (8) a second sensor support arm 460. These components are suitably connected such as shown.

The bottom guard 320 includes: (1) a bottom screen support structure 322; (2) a plurality of bottom screens (not labeled) connected to the bottom screen support structure 322; and (3) a lower front shield 330 connected to and extending downwardly from the bottom screen support structure 322.

The top guard 340 includes: (1) an upper screen support structure 342; (2) a plurality of upper screens (not labeled) connected to the upper screen support structure 342; and (3) an upper front shield 350 connected to and extending upwardly from the upper screen support structure 342. These components are suitably connected such as shown.

The first side guard 360 includes a first panel connected to the first sides of the bottom screen support structure 322 and the upper screen support structure 342.

The second side guard 380 includes a second panel connected to the second sides of the bottom screen support structure 322 and the upper screen support structure 342.

The first support leg 400 includes a first upright support 410 and a first foot 412 connected to the bottom of the support 410 and configured to rest on and be connected to a first section of the floor spaced from the roller press 100. The support 410 is connected to a first end of the lower front shield 330 of the bottom guard 320 and to first end of the upper front shield 350 of the top guard 340. The first foot 412 defines a plurality of fastener openings (not shown) that are positioned, sized, shaped and otherwise configured to enable a plurality of fasteners (not labeled) that attach the foot 412, the leg 400, and the infeed guard assembly 300 to the first section of the floor spaced from the roller press 100.

The second support leg 420 includes a second upright support 430 and a second foot 432 connected to the bottom of the support 430 and configured to rest on and be connected to a second section of the floor spaced from the roller press 100. The support 430 is connected to second end of the lower front shield 330 of the bottom guard 320 and to a second end of the upper front shield 350 of the top guard 340. The second foot 432 defines a plurality of fastener openings (not shown) that are positioned, sized, shaped and otherwise configured to enable a plurality of fasteners (not labeled) to attach the foot 432, the leg 420, and the infeed guard assembly 300 to the second section of floor spaced from the roller press 100.

The infeed canopy 310 and specifically: (1) the bottom guard 320; (2) the top guard 340; (3) the first side guard 360; (4) the second side guard 380; (5) the first support leg 400; and (6) the second support leg 420, define an infeed channel 490 having a channel outlet (not labeled) adjacent to the roller press 100 and an channel inlet (not labeled) between the lower front shield 330 and the upper front shield 350.

The infeed channel 490 is positioned, sized, shaped, and otherwise configured to allow a partially built truss (such as described above) to move though the infeed channel 490 and into the roller press 100, but to prevent an operator or any part of the operator from moving into the infeed channel 490 and into the roller press 100.

The infeed canopy 310 is configured to be easily and quickly attached to the infeed side of the roller press 100.

As best shown in FIG. 8, the infeed canopy 310 further includes roller press connection members such as four brackets 480, 482, 484, and 486 that are suitably connected to the upper and lower panels (not labeled) of the infeed side of the roller press 100 adjacent the infeed opening 124 of the roller press 100 and that are configured to engage and support the respective inner members of the bottom guard 320 and the top guard 340. The brackets 480, 482, 484, and 486 facilitate the attachment of the infeed canopy 310 to the infeed side 122 of the roller press 100. The quantity, positions, and configurations of these roller press connection members can vary in accordance with the present disclosure.

As partially shown in FIG. 9, the first side guard 360 and the second side guard 380 respectively include inner tongues (not labelled) configured to extend into opposite sides of the inlet 124 of the roller press 100 to further facilitate the attachment of the infeed canopy 310 to the infeed side 122 of the roller press 100.

The first sensor support arm 440 is connected to and extends transversely from the support 410 of the first support leg 400 in a direction opposite the direction of the roller press 100.

The second sensor support arm 460 is connected to and extends transversely from the support 430 of the first support leg 400 in a direction opposite the direction of the roller press.

The first sensor assembly 500 includes a cable pull sensor that detects movement of the physical cable and triggers an e-stop condition.

More specifically, the first sensor assembly 500 includes a first cable holder and detector 510 connected to the first sensor support arm 440, a second cable holder 520 connected to the second sensor support arm 460, and a cable 530 connected and extending between the first cable holder and detector 510 the second cable holder 520. The cable 530 extends above the infeed channel inlet.

The first sensor assembly 500 is configured to send a signal to the controller (not labeled) of the roller press 100 when the detector 510 detects the movement of the cable 530 (that can indicate that an operator engaged the cable 530), such that the e-stop controller (not shown) will actuate the brake (no shown) on the motor (not labeled). The roller press 100 can be configured to be manually restarted. The roller press 100 can also be configured to provide one or more alerts or other indicators of such actions.

The second sensor assembly 550 includes an optical sensor that detects movement of a truss moving in the infeed channel 490 of the infeed canopy 310.

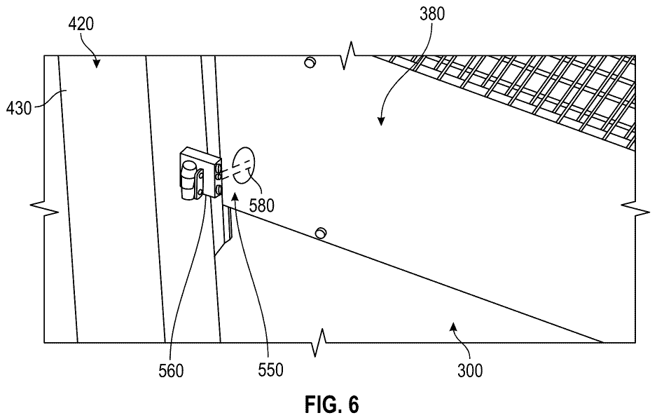

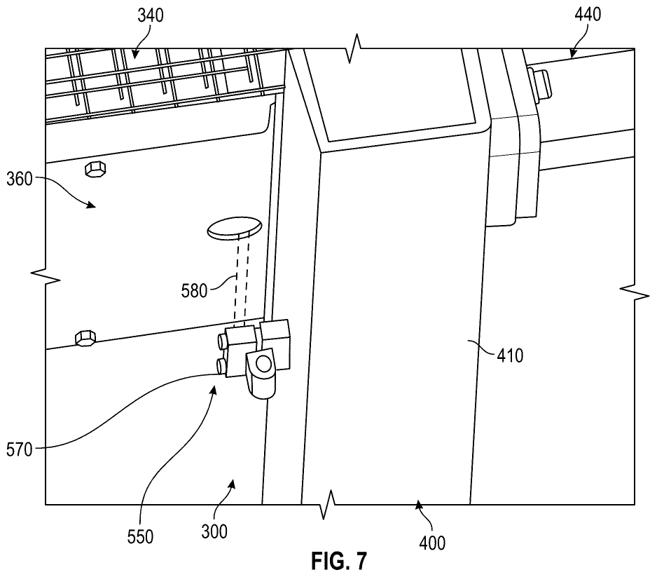

More specifically, the second sensor assembly 550 includes a light transmitter 560 connected to the support 430 of the second support leg 420 and a light receiver 570 connected to the support 410 of the first support leg 40 as best shown in FIGS. 6 and 7.

The light transmitter 560 is configured to direct a light beam 580 through an opening (not labeled) in the second side guard 380, through the infeed channel 490, through an opening (not labeled) in the first side guard 360 (that is aligned with the opening in the second side guard 380) and to the light receiver 570.

When a truss enters the infeed channel 490 of the infeed canopy 310, the truss will block the light beam 380 that extends through the infeed channel 490 and the light receiver 570 will send a signal to the controller. The controller is then programmed to cause the light 860 to illuminate and an audible alarm (not shown) in assembly 850 on the outfeed guard assembly 600 to alert an operator on the outfeed side of the roller press 100 that a truss is moving into the roller press 100 and thus will be moving out of the roller press 100 and out of the outfeed guard assembly 600. The light receiver 570 can also be configured to send a signal to the controller of the roller press 100.

### Outfeed Guard Assembly

The outfeed guard assembly 600 is sized, shaped, and otherwise configured to be positioned adjacent to and connected to the outfeed side 130 of the main roller section 120 and partially in the outlet 134.

The outfeed guard assembly 600 includes: (1) an outfeed canopy 610; (2) a third sensor assembly 800 connected to and supported by the outfeed canopy 610; and (3) a truss indicator assembly 850 connected to and supported by the outfeed canopy 610.

The outfeed canopy 610 includes: (1) a bottom guard 620; (2) a top guard 640; (3) a first side guard 660; (4) a second side guard 680; (5) a first support leg 700; (6) a second support leg 720; (7) a first sensor support arm 740; and (8) a second sensor support arm 760. These components are suitably connected such as shown.

The bottom guard 620 includes: (1) a bottom screen support structure 622; (2) a plurality of bottom screens (not labeled) connected to the bottom screen support structure 622; and (3) a lower front shield 630 connected to and extending downwardly from the bottom screen support structure 622.

The top guard 640 includes: (1) an upper screen support structure 642; (2) a plurality of upper screens (not labeled) connected to the upper screen support structure 642; and (3) an upper front shield 650 connected to and extending upwardly from the upper screen support structure 642.

The first side guard 660 includes a first panel connected to the first sides of the bottom screen support structure 622 and the upper screen support structure 642.

The second side guard 680 includes a second panel connected to the second sides of the bottom screen support structure 622 and the upper screen support structure 642.

The first support leg 700 includes a first upright support 710 and a first foot 712 connected to the bottom of the support 710 and configured to rest on and be connected to a third section of the floor spaced from the roller press 100. The support 710 is connected to a first end of the lower front shield 630 of the bottom guard 620 and to first end of the upper front shield 650 of the top guard 640. The first foot 712 defines a plurality of fastener openings (not shown) that are positioned, sized, shaped and otherwise configured to enable a plurality of fasteners (not labeled) to attach the foot 712, the leg 700, and the outfeed guard assembly 600 to the third section of floor spaced from the roller press 100.

The second support leg 720 includes a second upright support 730 and a second foot 732 connected to the bottom of the support 730 and configured to rest on and be connected to a fourth section of the floor spaced from the roller press 100. The support 730 is connected to second end of the lower front shield 630 of the bottom guard 620 and to a second end of the upper front shield 650 of the top guard 640. The second foot 732 defines a plurality of fastener openings (not shown) that are positioned, sized, shaped and otherwise configured to enable a plurality of fasteners (not labeled) to attach the foot 732, the leg 720, and the outfeed guard assembly 600 to the fourth section of floor spaced from the roller press 100.

The outfeed canopy 610 and specifically: (1) the bottom guard 620; (2) the top guard 640; (3) the first side guard 660; (4) the second side guard 680; (5) the first support leg 700; and (6) the second support leg 720, define an outfeed channel 790 having a channel inlet (not labeled) adjacent to the roller press and a channel outlet (not labeled) between the lower front shield 630 and the upper front shield 650.

The outfeed channel 790 is positioned, sized, shaped, and otherwise configured to allow a built truss (such as described above) to exit the roller press 100 into and though the outfeed channel 790, but to prevent an operator or any part of the operator from moving into the outfeed channel 790 and into the roller press 100.

The outfeed canopy 610 is configured to be easily and quickly attached to the outfeed side 130 of the roller press 100.

As best shown in FIG. 10, the outfeed canopy 610 further includes roller press connection members such as four brackets 780, 782, 784, and 786 that are suitably connected to the upper and lower panels of the outfeed side 130 of the roller press 100 adjacent the outfeed opening 134 of the roller press 100 and that are configured to engage and support the respective inner members of the bottom guard 620 and the top guard 640. The brackets 780, 782, 784, and 786 facilitate the attachment of the outfeed canopy 610 to the outfeed side of the roller press 100. The quantity, positions, and configurations of these roller press connection members can vary in accordance with the present disclosure.

The first side guard 660 and the second side guard 680 respectively include inner tongues (not shown) configured to extend into the outlet 134 of the roller press 100 to further facilitate the attachment of the outfeed canopy 610 to the outfeed side 130 of the roller press 100.

The first sensor support arm 740 is connected to and extends transversely from the support 710 of the first support leg 700 in a direction opposite the direction of the roller press 100.

The second sensor support arm 760 is connected to and extends transversely from the support 730 of the first support leg 700 in a direction opposite the direction of the roller press 100.

The third sensor assembly includes a cable pull switch 800 that includes a cable pull sensor that detects movement of the cable and triggers the e-stop circuit in the controller. This e-stop circuit is configured to immediately activate the motor brake.

More specifically, the third sensor assembly 800 includes a third cable holder 810 connected to the third sensor support arm 740, a fourth cable holder and detector 820 connected to the fourth sensor support arm 760, and a second cable 830 connected and extending between the third cable holder 810 and the fourth cable holder and detector 820. The second cable 830 extends above the outfeed channel outlet 790.

The third sensor assembly 800 is configured to send an alert to the controller of the roller press 100 when the detector detects the movement of the second cable 830 (that can indicate that an operator engaged the second cable 830) such that the controller can stop operation of the roller press 100. The roller press 100 can be configured to be manually restarted. The roller press 100 can also be configured to provide one or more alerts or other indicators of such actions.

The truss indicator assembly 850 is connected to and supported by the outfeed guard 610.

The alarm and light assembly 850 can be mounted to the outfeed guard assembly for shipment. Depending upon the layout of location for the entire press assembly, the light and alarm assembly 850 can be positioned in another suitable location such as in a location disconnected from the entire press assembly.

In various embodiments, the controller (not shown) includes one or more manually controlled switching mechanisms.

In various embodiments, the controller includes one or more PLC boards or is integrated into one or more PLC boards.

In various embodiments, the controller includes one or more processing devices communicatively connected to one or more memory devices.

In various embodiments, the controller includes a programmable logic controller. The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

In various embodiments, the controller includes one or more memory devices. Each memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. Each memory device stores instructions executable by the processing device to control operation of the roller press assembly.

In various embodiments, the controller is communicatively and operably connected to the actuators including the servo motors, sensors, the operator interface, and the power supply, and configured to receive signals from and send signals to those components.

In various embodiments, the controller is communicatively connectable (such as via Wi-Fi, Bluetooth, near-field communication, or other suitable wireless communications protocol) to an external device, such as a computing device, to send information to and receive information from that external device.

The operator interface can include a suitable display screen with a touch panel. In such embodiments with a display screen, the display screen is configured to display information regarding the roller press assembly, and the touch screen is configured to receive operator inputs. The operator interface is communicatively connected to the controller to send signals to the controller and to receive signals from the controller. Other embodiments of the roller press assembly do not include a touch panel. Still other embodiments of the roller press assembly do not include a display assembly. Certain embodiments of the roller press assembly include a separate pushbutton panel instead of a touch panel beneath or integrated with the display screen. In certain embodiments of the roller press assembly, the operator interface includes one or more pushbuttons (and associated light) and no display screen or touch panel.

In various embodiments, the power supply is electrically connected to (via suitable wiring and other components) and configured to power several components of the roller press assembly. In various embodiments, the power supply can include a pneumatic air power supply.

It will be understood that modifications and variations may be affected without departing from the scope of the novel concepts of the present invention, and it is understood that this application is to be limited only by the scope of the claims.

1. A press assembly comprising:
a roller press including a main roller section having an infeed side defining an inlet and an outfeed side defining an outlet;
an infeed guard assembly positioned adjacent to the infeed side of the main roller section, the infeed guard assembly including:
an infeed canopy,
a first trip cable sensor assembly connected to the infeed canopy and configured to send a signal to the roller press to cause the roller press to stop operation, and
an optical sensor connected to the infeed canopy; and
an outfeed guard assembly positioned adjacent to the outfeed side of the main roller section, the outfeed guard assembly including:
an outfeed canopy,
a second trip cable sensor assembly connected to the outfeed canopy and configured to send a signal to the roller press to cause the roller press to engage a motor brake in to stop operation, and
a truss indicator assembly connected to the outfeed canopy and configured to indicate that a truss is moving through the main roller section based on a signal from the optical sensor.

2. The press assembly of claim 1, wherein the infeed guard assembly is connected to the infeed side of the main roller section and the outfeed guard assembly is connected to the outfeed side of the main roller section.

3. The press assembly of claim 1, wherein the infeed guard assembly is partially in the inlet, and the outfeed guard assembly is partially in the outlet.

4. The press assembly of claim 1, wherein the infeed canopy includes a bottom guard, a top guard, a first side guard, a second side guard, a first support leg, and a second support leg that define an infeed channel, and wherein the outfeed canopy includes a bottom guard, a top guard, a first side guard, a second side guard, a first support leg, and a second support leg that define an outfeed channel.

5. The press assembly of claim 4, wherein
the bottom guard of the infeed canopy includes:
a bottom screen support structure,
a plurality of bottom screens connected to the bottom screen support structure, and
a lower front shield connected to and extending downwardly from the bottom screen support structure; and
the top guard of the infeed canopy includes:
an upper screen support structure,
a plurality of upper screens connected to the upper screen support structure and
an upper front shield connected to and extending upwardly from the upper screen support structure.

6. The press assembly of claim 4, wherein:
the first support leg includes a first upright support and a first foot connected to the bottom of the support and configured to rest on and be connected to a first section of the floor spaced from the roller press; and
the second support leg includes a second upright support and a second foot connected to the bottom of the support and configured to rest on and be connected to a second section of the floor spaced from the roller press.

7. The press assembly of claim 1, wherein the infeed canopy includes a first sensor support arm and a second sensor support arm, wherein the first trip cable sensor is connected to the first sensor support arm and the second sensor support arm, wherein the out feed canopy includes a third sensor support arm and a fourth sensor support arm, wherein the second trip cable sensor is connected to the third sensor support arm and the fourth sensor support arm.

8. The press assembly of claim 1, wherein the infeed defines an infeed channel, and wherein the outfeed canopy define an outfeed channel.

9. The press assembly of claim 8, wherein the optical sensor is positioned to direct a light beam through the first side guard and the second side guard of the infeed canopy.

10. The press assembly of claim 6, wherein the infeed canopy includes roller press connection members connected to upper and lower panels of the infeed side of the main roller section adjacent the infeed opening of the main roller section.

11. The press assembly of claim 6, wherein the infeed canopy includes inner tongues configured to extend into opposite sides of the inlet of the main roller section.

12. A press assembly comprising:
a roller press including a main roller section having an infeed side defining an inlet and an outfeed side defining an outlet;
an infeed guard assembly positioned adjacent to the infeed side of the main roller section and connected to the infeed side of the main roller section, the infeed guard assembly including:
an infeed canopy partially in the inlet, the infeed canopy including s a bottom guard, a top guard, a first side guard, a second side guard, a first support leg, and a second support leg that define an infeed channel;
an outfeed guard assembly positioned adjacent to the outfeed side of the main roller section and connected to the outfeed side of the main roller section, the outfeed guard assembly including:
an outfeed canopy partially in the outlet, the outfeed canopy including a bottom guard, a top guard, a first side guard, a second side guard, a first support leg, a second support leg that define an outfeed channel.

13. The press assembly of claim 12, wherein
the bottom guard of the infeed canopy includes:
a bottom screen support structure,
a plurality of bottom screens connected to the bottom screen support structure, and
a lower front shield connected to and extending downwardly from the bottom screen support structure; and
the top guard of the infeed canopy includes:
an upper screen support structure,
a plurality of upper screens connected to the upper screen support structure and
an upper front shield connected to and extending upwardly from the upper screen support structure.

14. The press assembly of claim 13, wherein:
the first support leg includes a first upright support and a first foot connected to the bottom of the support and configured to rest on and be connected to a first section of the floor spaced from the roller press; and
the second support leg includes a second upright support and a second foot connected to the bottom of the support and configured to rest on and be connected to a second section of the floor spaced from the roller press.

15. The press assembly of claim 12, wherein the infeed canopy includes roller press connection members connected to upper and lower panels of the infeed side of the main roller section adjacent the infeed opening of the main roller section.

16. The press assembly of claim 15, wherein the infeed canopy includes inner tongues configured to extend into opposite sides of the inlet of the main roller section.
